(19) United States
(12) Patent Application Publication
(10) Pub. No.: US 2010/0119028 A1
(43) Pub. Date: May 13, 2010

(54) Nuclear reactor steam dryer manipulator

(75) Inventors: Mark A. Sloman, Lynchburg, VA (US); Chuck Werner, Lynchburg, VA (US); Frank Klahn, Lynchburg, VA (US); Russ Croucher, Lynchburg, VA (US); Bob Furter, Lynchburg, VA (US); Gary Pitcher, Lynchburg, VA (US)

Correspondence Address: Davidson, Davidson & Kappel, LLC, 485 7th Avenue, 14th Floor, New York, NY, 10018, US

(73) Assignee: AREVA NP INC, Lynchburg, VA (US)

(21) Appl. No.: 12/587,541

(22) Filed: Oct. 8, 2009

Related U.S. Application Data
(60) Provisional application No. 61/195,585, filed on Oct. 8, 2008.

(51) Int. Cl. G21C 17/00

(52) U.S. Cl. 376/249

(57) ABSTRACT

A BWR steam dryer remote visual inspection system including a support moveable along a first axis over the steam dryer, the support having a longitudinal direction; a trolley movable along the support in the longitudinal direction; a mast fixed to the trolley and moveable at a predetermined angle with respect to a plane defined by the first axis and longitudinal direction; and a camera coupled to an end of the mast.

Priority to U.S. Provisional patent application Ser. No. 61/195,585 filed Oct. 8, 2008, is claimed, the entire disclosure of which is hereby incorporated by reference.

The present invention relates generally to nuclear reactor service manipulators for steam dryers.

### BACKGROUND OF THE INVENTION

During the refueling outages at Boiling Water Nuclear Reactor (BWR) plants, the steam dryer is typically positioned in the refueling canal and visually examined to verify the integrity of its structural welds. Since the steam dryer is highly radioactive, the examination is performed remotely and underwater.

Many steam dryers BWR reactors have been inspected and have required weld repairs in order to continue to operate. Strict inspection requirements are now in place that require utilities to perform inspections on most of the horizontal and vertical welds used to form the dryer assembly. These dryer inspections have increased maintenance schedules while the utilities continue to drive outage durations down.

Previously inspections were performed manually off long poles while the operators stood in either side of the pool or on an auxiliary bridge or platform. This was time consuming, expended dose, required many crew members and did not provide a stable inspection platform.

U.S. Pat. No. 7,092,477 discloses a BWR inspection manipulator in which the manipulator is supportable on the BWR reactor shroud and inspects the areas adjacent a BWR shroud without obstructing refueling. The inspection manipulator has an arm extending on an inboard and an outboard side of the BWR body. This patent is hereby incorporated by reference herein.

### SUMMARY OF THE INVENTION

An object of the present invention is to provide a visual inspection manipulator for a BWR steam dryer which is of high quality video and from a stable platform. A further additional or alternative object is to provide shorter inspection times of the BWR dryer with less radiation dose expended and without using an existing refuel or auxiliary bridge.

The present invention provides a BWR steam dryer remote visual inspection system including a support moveable along a first axis over the steam dryer, the support having a longitudinal direction; a trolley movable along the support in the longitudinal direction; a mast fixed to the trolley and moveable at a predetermined angle with respect to a plane defined by the first axis and longitudinal direction; and a camera coupled to an end of the mast.

### BRIEF DESCRIPTION OF THE DRAWINGS

One preferred embodiment of the present invention will be described with respect to the drawing in which:

FIG. 1 shows a sectional view, with parts cut away, of a boiling water nuclear reactor pressure vessel; and

FIG. 2 shows an embodiment of the present invention of a BWR inspection manipulator.

### DETAILED DESCRIPTION

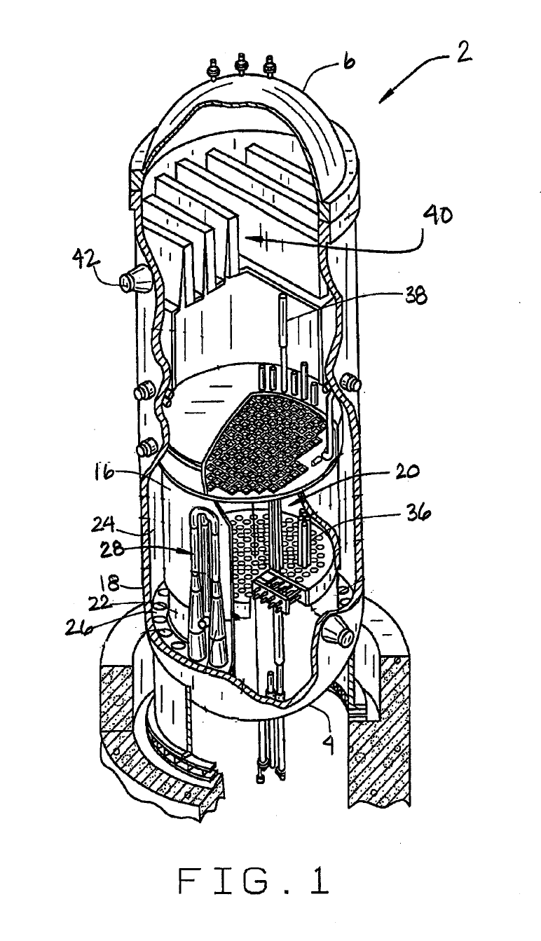

FIG. 1 shows a sectional view, with parts cut away, of a boiling water nuclear reactor pressure vessel 2. Reactor pressure vessel 2 is typically cylindrical in shape and closed on one end by a bottom end 4 and on the other end by a top head 6. Top head 6 is removable. A side wall 18 extends from top head 6 to bottom end 4. A reactor core 20 is surrounded by a shroud 16. An annulus 24 is formed between shroud 16 and sidewall 18. A pump deck 26 extends between the base of shroud 16 and side wall 18. Pump deck 26 is ring shaped and has circular openings used to house jet pumps 28. Jet pumps 28 are circumferentially distributed around shroud 16. Reactor core 20 includes fuel bundles 36 of fissionable material, which cause reactor core 20 generate heat. Water is circulated up through core 20 and partially converted to steam. Steam separators 38 separate steam from water, which is recirculated. Residual water is removed from the steam by steam dryers 50. Steam exits the reactor pressure vessel through a steam outlet 42 near top head 6.

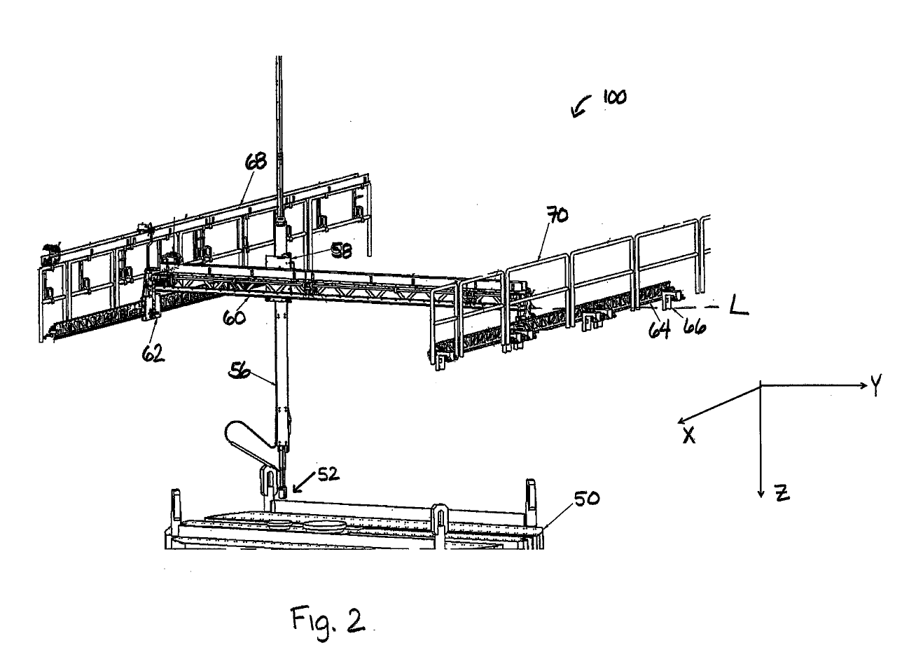

FIG. 2 shows a steam dryer shell 50 of a BWR reactor and a steam dryer remote system (SDRS) 100. SDRS 100 is an orthogonal, three degree of freedom manipulator used to remotely position a camera 52 near a weld on steam dryer 50 to perform an examination of the weld. Camera 52 can pan, tilt and zoom. Camera 52 is positioned on a long pole 53 that is positioned vertically by a mast 56. Mast 56 is mounted on a remote center trolley assembly 58 which moves mast 56 in direction Z. Center trolley 58 is moved along a bridge 60 in direction Y. Bridge 60 spans the longitudinal direction L and is mounted on two side trolleys 62. Side trolleys 62 are driven by a common shaft to assure they move in unison along the sides of the refueling canal in an X direction. Side trolleys 62 travel along two identical sets of side tracks 64. Side tracks 64 are mounted along the length of the refueling canal. Side tracks 64 are supported by a series of track hangers 66. Track hangers 66 hook over the curbs of the canal to support side tracks 64. The SDRS 100 includes cables managed in two cable chains, e.g., two IGUS brand cable chains. A first cable chain is supported by a series of trays 68. Trays 68 are mounted to the refueling pool hand rails 70. A second cable chain is contained in trays that mount along the top of the axis of bridge 60. Except for the first cable tray 68, the SDRS 100 can be entirely contained inboard of the refueling canal hand rails 70.

All three axes of SDRS 100 are driven by brushless DC gear-motors with integral fail-safe brakes that are able to move at speeds of up to 1 foot per second, one motor for moving mast 56 in the Z direction, a second motor for driving bridge 60 in the X direction and a third motor for driving trolley 58 in the Y direction. The resulting system is capable of rapidly and remotely positioning camera 52 at any location around dryer 50 to permit visual examination of the welds. This three dimension arrangement is a simpler and more cost effective design than previous devices.

SDRS 100 can be manually controlled using simple encoded joystick controls or remotely controlled by a computer.

The control software of SDRS 100 utilizes a 3D graphical display for control. The operator can simply position and click the mouse on the start of a weld and SDRS 100 moves camera 52 to a start position. The software utilizes state of the art path planning code to pick the correct path to move the tool safely. In addition, the software is equipped with collision avoidance that ensures that the tool slows down in tight areas and stops when necessary. The tool design uses robust simple drive components to manipulate the three axis. A single motor is used with multiple gear boxes to drive two sprockets on opposite rails so that bridge 60 drives straight.

Because the present invention can be used for inboard use only to inspect the steam dryer, it requires a less complex and more cost effective structure than prior art that is for both inboard and outboard use.

What is claimed is:

1. A BWR steam dryer remote visual inspection system comprising:
a support moveable along a first axis over the steam dryer, the support having a longitudinal direction;
a trolley movable along the support in the longitudinal direction;
a mast fixed to the trolley and moveable at a predetermined angle with respect to a plane defined by the first axis and longitudinal direction; and
a camera coupled to an end of the mast.

2. The BWR steam dryer remote system as recited in claim 1 wherein the predetermined angle is 90 degrees.

3. The BWR steam dryer remote system as recited in claim 1 wherein the mast moves vertically.

4. The BWR steam dryer remote system as recited in claim 1 wherein the camera is adapted to pan, tilt and zoom.

5. The BWR steam dryer remote system as recited in claim 1 wherein the support is adjustable to be contained entirely inboard of refueling canal hand rails.

6. The BWR steam dryer remote system as recited in claim 1 further comprising two side trolleys, wherein the support is mounted on the two side trolleys.

7. The BWR steam dryer remote system as recited in claim 6 further comprising a common shaft, wherein the side trolleys are driven by the common shaft.

8. The BWR steam dryer remote system as recited in claim 6 further comprising side tracks mounted on a refueling canal, wherein the side trolleys travel along the side tracks.

9. The BWR steam dryer remote system as recited in claim 8 further comprising hangers, wherein the side tracks are supported on the canal with the hangers.

10. The BWR steam dryer remote system as recited in claim 1 further comprising a brushless DC gear motor with integral fail safe brakes, wherein the support is driven by the brushless DC gear motor.

11. The BWR steam dryer remote system as recited in claim 1 further comprising an interface for manually controlling the system.

12. The BWR steam dryer remote system as recited in claim 1 further comprising a computer for remotely controlling the system.

13. The BWR steam dryer remote system as recited in claim 1 further comprising a brushless DC gear motor with integral fail safe brakes, wherein the trolley is driven by the brushless DC gear motor.

14. The BWR steam dryer remote system as recited in claim 1 further comprising a brushless DC gear motor with integral fail safe brakes, wherein the mast is driven by the brushless DC gear motor.
